(19) United States
(12) Patent Application Publication
(10) Pub. No.: US 2011/0248973 A1
(43) Pub. Date: Oct. 13, 2011

(54) BRIGHTNESS CONTROL DRIVE CIRCUIT FOR A CURRENT-DRIVEN DISPLAY DEVICE

(75) Inventors: FREDERICK F. KUHLMAN, KOKOMO, IN (US); MICHAEL J. MELEASON, KOKOMO, IN (US); MARK L. RAYL, KEMPTON, IN (US)

(73) Assignee: DELPHI TECHNOLOGIES, INC., TROY, MI (US)

(21) Appl. No.: 12/757,284

(22) Filed: Apr. 9, 2010

(51) Int. Cl. G09G 5/00

(52) U.S. Cl. 345/207

(57) ABSTRACT

A current-driven display device includes sub-pixel drive circuits with integral photo-sensitive circuits that modify the respective sub-pixel drive currents as a function of the locally sensed ambient light level. The photo-sensitive circuit may include a photo-transistor or photo-resistor connected in the output circuit of a drive transistor used to control the on-off state of a respective sub-pixel element, or the photo-sensitive circuit may include a photo-resistor that adjusts a control voltage or current supplied to an input circuit of the drive transistor. In any event, the photo-sensitive circuits individually and independently adjust the drive current, and hence the luminance, of each sub-pixel element based on the locally sensed ambient light level to locally and dynamically compensate for changes in ambient light impinging on the display device.

### TECHNICAL FIELD

The present invention relates to current-driven display devices such as organic light-emitting diode (OLED) displays, and more particularly to a brightness control drive circuit that automatically adjusts the display device brightness to compensate for changes in incident ambient lighting.

### BACKGROUND OF THE INVENTION

Usage of color display devices in motor vehicle instrument panels and consoles has increased dramatically with the advent of various OEM electronic systems such as navigation, rear-vision, lane guidance, and night-vision, to name a few. Among the more promising display technologies for automotive usage are current-driven display devices such as organic light-emitting diode (OLED) displays, but even these displays have difficulty meeting the required contrast ratio in high ambient lighting conditions unless the display brightness is set to maximum. However, indiscriminately commanding the display to maximum brightness is not realistic, and doing so unnecessarily degrades the life of the display as well. Moreover, the amount of brightness enhancement (if any) needed to compensate for ambient lighting may be different in different areas of the display. Accordingly, what is needed is a selective and cost-effective way of automatically adjusting the brightness of a current-driven display device such as an OLED display to compensate for changes in incident ambient lighting.

### SUMMARY OF THE INVENTION

The present invention is directed to an improved current-driven display device having sub-pixel drive circuits with integral photo-sensitive circuits that modify the respective sub-pixel drive currents as a function of the locally sensed ambient light level. The photo-sensitive circuit may include a photo-transistor or photo-resistor connected in the output circuit of a drive transistor used to control the on-off state of a respective sub-pixel element, or the photo-sensitive circuit may include a photo-resistor that adjusts a control voltage or current supplied to an input circuit of the drive transistor. In any event, the photo-sensitive circuits individually and independently adjust the drive current, and hence the luminance, of each sub-pixel element based on the locally sensed ambient light level to locally and dynamically compensate for changes in ambient light impinging on the display device.

### BRIEF DESCRIPTION OF THE DRAWINGS

FIG. 1 is a diagram of drive circuitry for a current-driven display device, including a matrix of sub-pixel drive circuits.

FIG. 2A is a circuit diagram of a sub-pixel drive circuit according to a first embodiment of this invention.

FIG. 2B is a circuit diagram of a sub-pixel drive circuit according to a second embodiment of this invention.

FIG. 2C is a circuit diagram of a sub-pixel drive circuit according to a third embodiment of this invention.

### DESCRIPTION OF THE PREFERRED EMBODIMENT

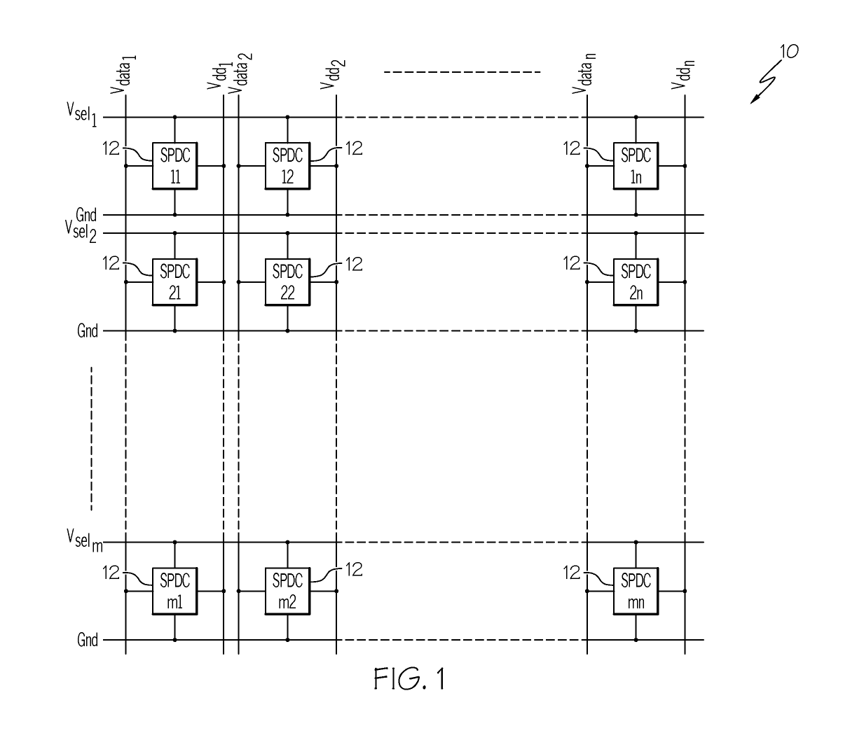

Referring to the drawings, and particularly to FIG. 1, the reference numeral 10 generally designates a current-driven display device such as organic light-emitting diode (OLED) display, and more specifically, drive circuitry for an m-by-n matrix of display device sub-pixel elements 14. A display control circuit, not shown, produces the illustrated row and column control signals, including a ground voltage (Gnd), a set of digital row-select signals Vsel₁-Vselₘ, a set of digital data signals Vdata₁-Vdataₙ, and a set of power voltages Vdd₁-Vddₙ. A matrix of m·n sub-pixel driver circuits (SPDC) 12 are controlled by the row and column control signals to selectively activate the respective sub-pixel elements 14 to emit light and produce a display image or video frame.

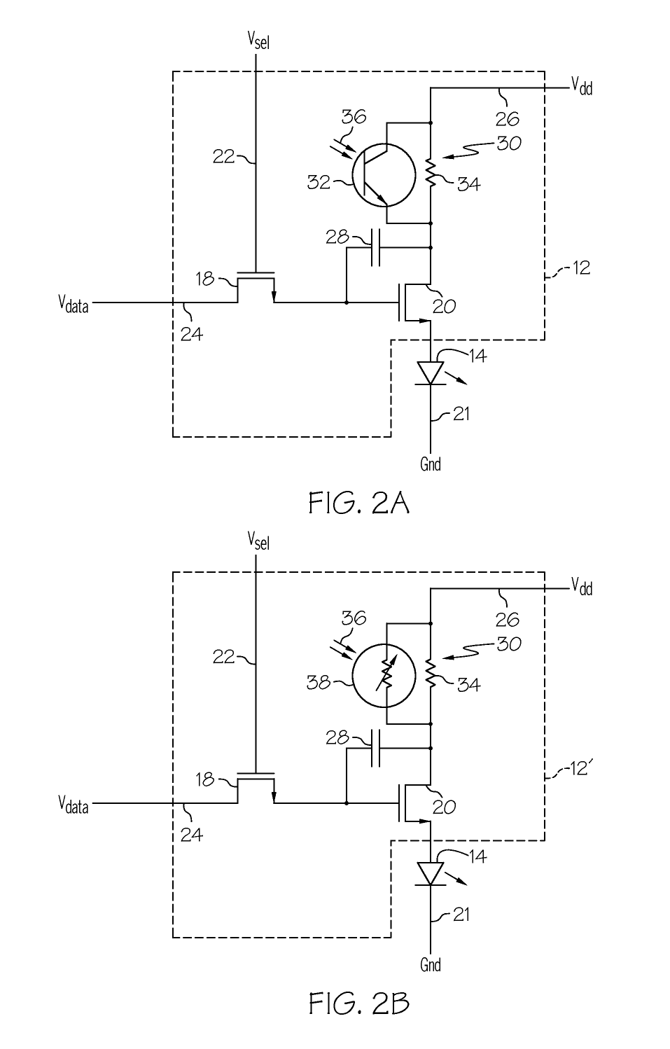

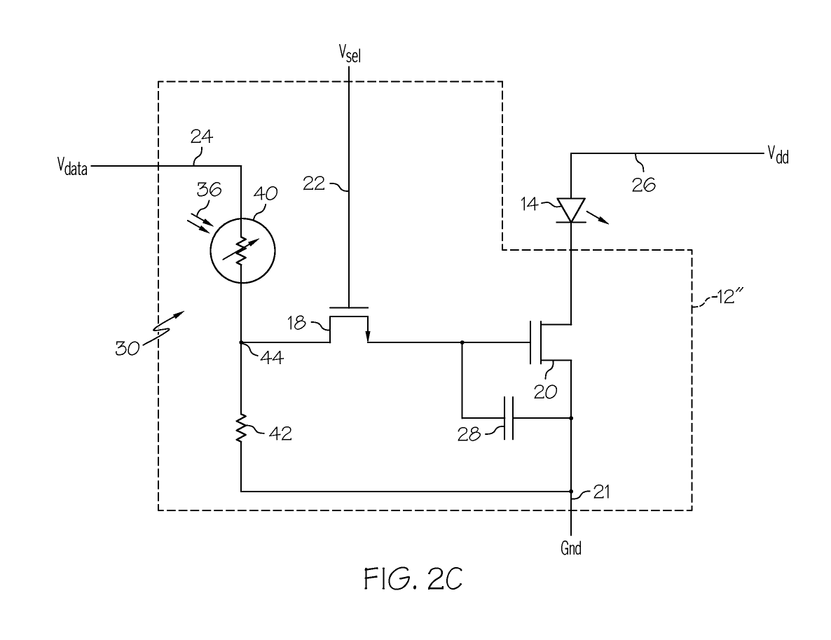

Referring to FIGS. 2A-2C, each of the sub-pixel driver circuits 12 includes a drive transistor 20 and a photo-sensitive circuit 30 for locally sensing a level of ambient light and modifying a current supplied to a respective sub-pixel element 14 by the drive transistor 20 such that the intensity of light emitted by the sub-pixel element 14 changes with the level of locally sensed ambient light. The current supplied to each sub-pixel element 14 of the display device 10 is individually controlled in this way so that the display brightness is locally and dynamically compensated for changes in ambient light impinging on the display device 10.

FIG. 2A depicts a drive circuit 12 according to a first embodiment, FIG. 2B depicts a drive circuit 12′ according to a second embodiment, and 2C depicts a drive circuit 12″ according to a third embodiment. In each case, the drive circuit 12, 12′, 12″ is coupled to ground voltage Gnd via line 21, a respective power voltage Vdd via line 26, a respective data signal Vdata via line 24, and a respective row-select signal Vsel via line 22.

Referring to the first embodiment of FIG. 2A, the drive circuit 12 includes a field-effect drive transistor 20 that is digitally biased on and off by the respective row-select signal Vsel via the pre-drive transistor 18. The drive transistor 20 is configured as a high-side device, and the sub-pixel element 14 is connected between the source of drive transistor 20 and ground voltage Gnd. When Vsel is high, the pre-drive transistor 18 is biased on to supply the respective data signal Vdata to the gate of drive transistor 20 to activate or deactivate sub-pixel element 14 according to the data signal Vdata. When Vsel is low, the pre-drive transistor 18 is biased off, and the capacitor 28 controls the state transition (if any) of drive transistor 20.

The photo-sensitive circuit 30 is coupled to the output circuit of drive transistor 20, between the drain of drive transistor 20 and the respective power voltage Vdd. The photo-sensitive circuit 30 includes the parallel combination of photo-transistor 32 and resistor 34, the photo-transistor 32 having a collector-to-emitter on-resistance that varies indirectly with incident ambient light level, indicated by the arrows 36. Preferably, the resistance of resistor 34 is selected such that under dark or low-nominal ambient lighting conditions, the sub-pixel element 14 emits light of desired intensity. As the incident light impinging the photo-transistor 32 increases, its on-resistance decreases to proportionately increase the current supplied to sub-pixel element 14 via drive transistor 20 (when biased on). As a result, the intensity of light emitted by sub-pixel element 14 varies in direct relation to the ambient light incident on photo-transistor 32. This effect occurs independently at each sub-pixel element of display 10 so that the display brightness changes locally and dynamically as required to compensate for changes in ambient light impinging on the display device 10.

Referring to the second embodiment of FIG. 2B, the drive circuit 12′ differs from the drive circuit 12 of FIG. 2A only in the composition of photo-sensitive circuit 30. In the second embodiment, the photo-transistor 32 of FIG. 2A is replaced with a photo-resistor 38, the resistance of which varies indirectly with incident ambient light level, indicated by the arrows 36. The resistance of resistor 34 may be selected as described in the preceding paragraph, and the same direct relationship between display brightness and incident ambient lighting is obtained.

Referring to third embodiment of FIG. 2C, the drive circuit 12″ includes an enhancement-mode field-effect drive transistor 20 whose drain-to-source conduction is controlled by a control voltage at circuit node 44 when the pre-drive transistor 18 is biased on by the respective row-select signal Vsel. In this arrangement, the drive transistor 20 is configured as a low-side device, and the sub-pixel element 14 is connected between the drain of drive transistor 20 and the respective power voltage Vdd. When Vsel is high, the pre-drive transistor 18 is biased on to supply the control voltage at node 44 to the gate of drive transistor 20, and the drain-to-source conduction of drive transistor 20 varies in direct relation to the magnitude of the control voltage at node 44. And as above, the pre-drive transistor 18 is biased off when Vsel is low, with the capacitor 28 controlling the state transition (if any) of drive transistor 20.

The photo-sensitive circuit 30 is coupled in the input circuit of drive transistor 20, and adjusts the control voltage at node 44 as a function of incident ambient lighting. In this embodiment, the photo-sensitive circuit 30 is configured as a voltage divider, including a photo-resistor 40 coupling the respective data signal Vdata to circuit node 44, and a resistor 42 connected between circuit node 44 and ground voltage Gnd. The resistance of resistor 42 is selected such that under dark or low-nominal ambient lighting conditions, the sub-pixel element 14 emits light of desired intensity. As the incident light impinging the photo-resistor 40 increases, its resistance decreases to proportionately increase the control voltage at node 44, and hence, the intensity of light emitted by sub-pixel element 14 (when Vdata and Vsel are both high). As with the other embodiments, this effect occurs independently at each sub-pixel element of display 10 so that the display brightness changes locally and dynamically as required to compensate for changes in ambient light impinging on the display device 10.

In summary, the present invention provides a current-driven display device having photo-sensitive sub-pixel drive circuits for individually and cost-effectively adjusting the brightness of each sub-pixel element to locally and dynamically compensate for changes in ambient light impinging on the display device. While the present invention has been described with respect to the illustrated embodiment, it is recognized that numerous modifications and variations in addition to those mentioned herein will occur to those skilled in the art. For example, it will be recognized that while the photo-sensitive circuits 30 of this invention have been disclosed in the context of specific sub-pixel driver circuits, the illustrated driver circuits are merely representative of driver circuit topologies that can be used for current-driven display devices, and the photo-sensitive circuits 30 may be equally applicable to other driver circuit topologies. Accordingly, it is intended that the invention not be limited to the disclosed embodiments, but that it have the full scope permitted by the language of the following claims.

1. A current-driven display device including a matrix of sub-pixel elements, each of which is selectively activated by a respective drive transistor to emit light, the display device comprising:
for each drive transistor, a photo-sensitive circuit connected in an input circuit or an output circuit of said drive transistor for locally sensing a level of ambient light and modifying a current supplied to a respective sub-pixel element by said drive transistor such that an intensity of light emitted by the respective sub-pixel element changes with the level of locally sensed ambient light to locally and dynamically compensate for changes in ambient light impinging on said display device.

2. The current-driven display device of claim 1, where said photo-sensitive circuit comprises:
a photo-transistor or photo-resistor connected in the output circuit of said drive transistor; and
a resistor connected in parallel with said photo-transistor or photo-resistor.

3. The current-driven display device of claim 2, where:
a resistance of said photo-resistor varies inversely with the level of locally sensed ambient light.

4. The current-driven display device of claim 2, where:
an on-resistance of said photo-transistor varies inversely with the level of locally sensed ambient light.

5. The current-driven display device of claim 1, where said photo-sensitive circuit comprises:
a photo-resistor connected in the input circuit of said drive transistor; and
a divider resistor connected to a junction between said drive transistor and said photo-resistor, where a control voltage at said junction controls a conduction of said drive transistor.

6. The current-driven display device of claim 5, where:
a resistance of said photo-resistor varies inversely with the level of locally sensed ambient light so that said control voltage and the conduction of said drive transistor vary directly with the level of locally sensed ambient light.
